(19) United States
(12) Patent Application Publication
(10) Pub. No.: US 2026/0127524 A1
(43) Pub. Date: May 7, 2026

(54) ELECTRONIC WORK PERMIT FOR MANAGING FIELD WORK

(71) Applicant: FYLD Limited, London (GB)

(72) Inventors: Matthew Lewis, Hitchin, Hertfordshire (GB); Joshua Wood, London (GB); Yulia Lamonova, London (GB); John Haynes, Eastbourne (GB)

(21) Appl. No.: 19/117,551

(22) PCT Filed: Oct. 4, 2022
(86) PCT No.: PCT/EP2022/077610

§ 371 Date: Apr. 1, 2025

(51) Int. Cl. G06Q 10/0633; G06V 10/764

(52) U.S. Cl. CPC G06Q 10/0633; G06V 10/764

(57) ABSTRACT

Embodiments of the present disclosure provide a computer implemented method for analyzing a video from a location to enable obtaining electronic work permit authorizing a scope of work to be performed at a location. The method is being performed by a client application executed at a second electronic device. The method comprises receiving, from a first electronic device at the location, a permit authorization request message comprising an input identifying the scope of work to be performed at the location. In response to receiving the permit authorization request message. the method comprises transmitting a response message to the first electronic device indicating whether or not the work permit is authorized for the scope of work.

The present disclosure relates generally to the field of work management systems. More particularly, it relates to computer-implemented methods, electronic devices and computer program products for usage of an electronic work permit for managing a work to be performed at a location/work site.

In general, industries such as, but are not limited to, construction industries, energy and utilities industries, or the like, involve day-to-day work (also be referred to as field work, field operations, or the like) to be performed at a location/work site. The work at the location has to be performed in compliance with field work management requirements defined based on state, local, and federal laws, a type of work, a work site, and so on. The field work management requirements include multiple regulations, codes and standards with regard to health and safety of workers, environmental protection, and quality management.

For performing the work in compliance with the field work management requirements, a worker entitled to work at the location has to obtain a work permit from an authorizing entity (for example, managers, work site administrators, authorizing engineers, officers in charge of the location, or the like). Not having the work permit is a blocker for the worker to carry out the work at the location.

In conventional approaches, the worker can obtain the work permits by following legacy paper based processes or using dedicated permit-management digital solutions.

The legacy paper based processes involve obtaining the work permits in written forms/paper-based forms being completed and signed by the authorizing entity. In order to obtain the work permits in the written forms, the worker has to pause the work, drive to an office of the authorizing entity, complete request forms and obtain the written forms being signed by the authorizing entity. In some scenarios, the authorizing entity needs to drive to the location to ensure that all the required set up to perform the work at the location is in place to authorize the work permit. In some scenarios, the authorizing entity may not have immediate visibility of which work permits are open, and which are about to expired and need renewal. Thus, obtaining the work permit in accordance with the legacy paper based processes consume time and delay the work to be performed at the location.

Further, the legacy paper based processes involve providing the work permit to the worker by focusing on managing longer-term local council permissions at the location, which are obtained weeks or days before the work starts.

The dedicated permit-management digital solutions can allow the worker to obtain the work permits in digital forms by providing information about the work and/or the location. However, such digital forms are authorized without any evidence/validation of the information.

### SUMMARY STATEMENTS

The following statements summarise some aspects and embodiments of the disclosed technology, however, the scope of the invention is as defined by the accompanying claims.

It is important for a worker to obtain a work permit for performing work at a location/work site. However, the work permits can be in paper-based forms or digital forms, wherein obtaining the paper-based forms consume time and delay the work to be performed at the location and the digital form can be authorized without validating information provided by the worker. Moreover, the information required to obtain a permit may be dependent on the location as different regulations may apply for the same scope of work at different locations, for example, where a permit for a scope of work at a location is governed by a different regulatory authority to the regulatory authority granting permits for the same scope of work at another location.

Consequently, there is a need for an improved method and arrangement for usage of an electronic work permit for managing and/or performing work at a location, wherein the electronic work permit authorizes a scope of work to be performed at a location.

Therefore an object of the present disclosure seeks to provide computer implemented methods, electronic devices, a computer program product, and a work management system for managing a work at a location using an electronic work permit authorizing a scope of work to be performed at a location, which mitigate, alleviate, or eliminate all or at least some of the above-discussed drawbacks of presently known solutions.

This and other objects are achieved by means of computer implemented methods, electronic devices, a computer program product, and a work management system, as defined in the appended claims. The term exemplary is in the present context to be understood as serving as an instance, example or illustration.

According to a first aspect of the present disclosure, a computer implemented method for providing an electronic work permit authorizing a scope of work to be performed at a location is provided. The method is being performed by a client application executed at a second electronic device. The method comprises receiving, from a first electronic device, a permit authorization request message comprising an input identifying the scope of work to be performed at the location. In response to receiving the permit authorization request message, the method comprises transmitting a response message indicating whether or not the work permit is authorized for the scope of work.

In some embodiments, the method allows multiple electronic work permits to be obtained and monitored concurrently via the second electronic device for a plurality of different locations.

In some embodiments, the scope of work is a scope of work performed by machinery operated by a user, either on site or, for example, remotely.

In some embodiments, the scope of work is a scope of work performed by machinery operated by another machine entity, for example, a robot.

In some embodiments the machinery is autonomous machinery.

In some embodiments, the transmitting of the response message to the first electronic device indicating whether or not the work permit is authorized for the scope of work comprises determining whether the received input identifying the scope of the work to be performed at the location is in compliance with an authorization criteria to be fulfilled for authorizing the work permit. The method may further comprise transmitting the response message to the first electronic device indicating whether or not the work permit is authorized for the scope of work based on the determination.

In some embodiments, the step of determining whether the received input identifying the scope of the work to be performed at the location is in compliance with the authorization criterial to be fulfilled for authorizing the work permit comprises obtaining an image and/or a video of the location from the received input. The method may then comprise determining whether the authorization criteria is fulfilled or not based on analysis of the image and/or the video of the location.

In some embodiments, the response message comprising the electronic work permit is transmitted as a push message to the first electronic device.

In some embodiments, the response message further comprises one or more of: an authorization for the work permit, a date of expiry of the work permit, a time interval indicating the expiry of the work permit, a rejection of the work permit and a reason for rejection of the work permit when the work permit is rejected.

In some embodiments, the method further comprises transmitting a permit expiry indication message to the first electronic device indicating an expiry of the work permit prior to the expiry of the work permit.

In some embodiments, the step of transmitting the permit expiry indication message to the first electronic device comprises identifying a date of expiry of the work permit authorized for the scope of the work. The method comprises monitoring whether the work permit is about to expire based on the identified date of expiry of the work permit. The method comprises transmitting the permit expiry indication message to the first electronic device prior at a pre-configured time interval prior to the expiry of the work permit.

In some embodiments, the method further comprises determining whether the scope of work being performed at the location requires an extension of work permit. In response to determining that the scope of work being performed at the location requires the extension of the work permit, the method comprises transmitting the response message to the first electronic device comprising the extension of work permit.

In some embodiments, the method allows multiple electronic work permits to be obtained and monitored concurrently via the second electronic device for a plurality of different locations.

In some embodiments, the method further comprises displaying, via the user interface, one or more of: a number of authorized work permits on a location map, a number of work permits about to expire, an indication for number of active work permits, an indication for the work permits that are about to expire, and one or more images of locations of the work being performed.

In some embodiments, an indication of the time remaining for each permit of the multiple electronic work permits is displayed via the user interface of the second electronic device. In some embodiments, the indication of the time remaining for each permit is displayed in a way that indicates if a current prediction of the time remaining for the work to be performed whilst the permit is value is greater or less than the time remaining for the permit. In some embodiments, a traffic light system may be used to indicate a probability of the work not being completed before the permit expires, so that red indicates a high probability of the work exceeding the time permitted under the permit for performing the work, orange a medium probability, and green indicates a low or no probability. Other colours may of course substitute for the other or another visual indication may be provided. Advantageously by displaying multiple indications at the same time on a map shown on the display of the second device in some embodiments, it allows a user perceiving the display of the second device to be able to more easily prioritize which permit to review, for example, to determine one or more characteristics of the work and/or the amount of time for the permit extension.

In some embodiments, an alert may be generated a predetermined amount of time before a permit expires to a permit authorizer to indicate an extension may be requested if the probability of the work not being completed whilst the permit is valid exceeds a threshold probability value. The predetermined amount of time may be set by a user, and may differ from location to location and for different permits. For example, a user may set an alert that if the work has a low likelihood of overrunning at one location for which a permit is quickly extended, that an alert is set for 30 minutes before expiry of the permit. However, for work at a different location, where the work has a high probability of overrunning and/or for which obtaining a permit extension may be more time-consuming, the alert may be generated 24 hours in advance so that there is sufficient time to obtain the permit extension or to take other action if the permit is not extendable directly.

Any suitable prediction technique may be used to determine if the work may be completed on time or not, however, in some embodiments the prediction of the amount of time remaining to complete the work is based on an input identifying a scope of work completed at a point in time. For example, an input comprising one or more of the following: a manual input by a remote user/entity, an input by a work-site user, for example, by a worker performing the work to which the work scope applies, an input generated by performing video analysis of the location indicating a scope of work completed by the point in time, and/or a previously input scope of work and/or the permit work scope. In some embodiments, the prediction is based on available resources for completing the work, for example, resources such as skilled worker availability and/or equipment availability and/or state of operability.

In some embodiments, the input identifying the scope of work comprises one or more of: an image of the location, a video of the location, characteristics of the scope of work, one or more equipment for performing the scope of work, an identifier, ID, of one or more workers competent to perform the work, competency information of one or more workers performing the work at the location, hazards identified at the location and a personal protective equipment, PPE, required for performing the work.

In some embodiments, the method further comprises transmitting the electronic work permit authorizing the scope of work to be performed at the location to the first electronic device without the first electronic device having previously transmitted to the second electronic device the permit authorization request message for the electronic work permit.

According to a second aspect of the present disclosure, a computer implemented method for obtaining an electronic work permit authorizing a scope of work to be performed at a location is provided. The method being performed by a client application executed at a first electronic device at the location. The method comprises obtaining, via a user interface, an input identifying the scope of work to be performed at the location, from a worker entitled to perform the work at the location. The method comprises transmitting a permit authorization request message comprising the obtained input to a second electronic device. In response to transmitting the permit authorization request message, the method comprises receiving from the second electronic device, a response message indicating whether or not the work permit is authorized for the scope of work.

In some embodiments, the step of obtaining the input identifying the scope of work to be performed at the location comprises capturing an image and/or a video of the location. The method comprises analysing the image and/or the video of the location for determining a set of characteristics of the scope of work. The method comprises determining the set of characteristics of the scope of work based on the analysis of the image and/or the video. The method comprises obtaining the input, via the user interface, for the determined set of characteristics of the scope of work.

In some embodiments, the step of determining the set of characteristics of the scope of work comprises identifying one or more of: a type and/or category of the work permit required for the scope of work, a unique identifier, ID, for the scope of the work, a set of one or more items of equipment for performing the scope of work, a set of one or more hazards identified based on the analysis of the image and/or the video, a set of one or more items of hazard mitigation for performing the scope of work, a personal protective equipment, PPE, required for performing the scope of work, one or more competent workers to perform the scope of work, and at least one skill required for at least one competent worker to safely perform the scope of work based on the set of determined characteristics.

In some embodiments, the input identifying the scope of work comprises one or more of: an image of the location, a video of the location, a set of characteristics of the scope of work, one or more equipment for performing the scope of work, an identifier, ID, of one or more workers competent to perform the work, competency information of one or more workers competent to perform the work, competency information of one or more workers performing the work at the location, hazards identified at the location, and a PPE required for performing the work.

In some embodiments, the response message comprises one or more of: an authorization for the work permit, a date of expiry of the work permit, a time interval indicating the expiry of the work permit, a rejection of the work permit, and a reason for rejection of the work permit when the work permit is rejected.

In some embodiments, the method further comprises receiving a permit expiry indication message from the second electronic device indicating an expiry of the work permit prior to the expiry of the work permit. The method further comprises receiving the response message from the second electronic device comprising an extension of the work permit when the work permit is about to expire.

In some embodiments, the method further comprises receiving the electronic work permit authorizing the scope of work to be performed at the location from the second electronic device without the first electronic device having previously transmitted to the second electronic device the permit authorization request message for the electronic work permit.

According to a third aspect of the present disclosure, a second electronic device for providing an electronic work permit authorizing a scope of work to be performed at a location through a client application executing on the second electronic device is provided. The second electronic device is adapted for receiving, from a first electronic device, a permit authorization request message comprising an input identifying the scope of work to be performed at the location. In response to receiving the permit authorization request message, the second electronic device is adapted for transmitting a response message indicating whether or not the work permit is authorized for the scope of work.

In some embodiments, the second electronic device is adapted for transmitting the response message to the first electronic device indicating whether or not the work permit is authorized for the scope of work by determining whether the received input identifying the scope of the work to be performed at the location is in compliance with an authorization criteria to be fulfilled for authorizing the work permit and transmitting the response message to the first electronic device indicating whether or not the work permit is authorized for the scope of work based on the determination.

In some embodiments the second electronic device is adapted for determining whether the received input identifying the scope of the work to be performed at the location is in compliance with the authorization criteria to be fulfilled for authorizing the work permit by obtaining an image and/or a video of the location from the received input and determining whether the authorization criteria is fulfilled or not based on analysis of the image and/or the video of the location.

In some embodiments the second electronic device, the response message comprising the electronic work permit is transmitted as a push message to the first electronic device.

In some embodiments of the second electronic device, the response message further comprises one or more of: an authorization for the work permit, a date of expiry of the work permit, a time interval indicating the expiry of the work permit, a rejection of the work permit and a reason for rejection of the work permit when the work permit is rejected.

In some embodiments, the second electronic device is further adapted for transmitting a permit expiry indication message to the first electronic device indicating an expiry of the work permit prior to the expiry of the work permit.

In some embodiments, the second electronic device is adapted for transmitting the permit expiry indication message to the first electronic device comprises identifying a date of expiry of the work permit authorized for the scope of the work, monitoring whether the work permit is about to expire based on the identified date of expiry of the work permit, and transmitting the permit expiry indication message to the first electronic device prior at a pre-configured time interval prior to the expiry of the work permit.

In some embodiments, the second electronic device is further adapted to determine whether the scope of work being performed at the location requires an extension of work permit and, in response to determining that the scope of work being performed at the location requires the extension of the work permit, transmit a response message to the first electronic device comprising the extension of work permit.

In some embodiments, the second electronic device is further adapted to: display, via the user interface, one or more of: a number of authorized work permits on a location map, a number of work permits about to expire, an indication for number of active work, an indication for the work permits that are about to expire, and one or more images of locations of the work being performed.

In some embodiments, an indication of the time remaining for each permit of a plural number of authorized work permits displayed on the location map is displayed with an indication of a prediction of work at each location being completed within the time remaining for each permit.

In some embodiments, the input identifying the scope of the work comprises one or more of: an image of the location, a video of the location, characteristics of the scope of work, one or more equipment for performing the scope of work, an identifier, ID, of one or more workers competent to perform the work, competency information of one or more workers performing the work at the location, hazards identified at the location and a personal protective equipment, PPE, required for performing the work.

According to a fourth aspect of the present disclosure, a first electronic device for obtaining an electronic work permit authorizing a scope of work to be performed at a location through a client application executing on the first electronic device at the location is provided. The first electronic device is adapted for obtaining, via a user interface, an input identifying the scope of work to be performed at the location, from a worker entitled to perform the work at the location. The first electronic device is adapted for transmitting a permit authorization request message comprising the obtained input to a second electronic device. In response to transmitting the permit authorization request message, the first electronic device is adapted for receiving, from the second electronic device, a response message indicating whether or not the work permit is authorized for the scope of work.

In some embodiments, the first electronic device is adapted to obtain the input identifying the scope of work to be performed at the location by: capturing an image and/or a video of the location, analysing the image and/or the video of the location for determining a set of characteristics of the scope of work, determining the set of characteristics of the scope of work based on the analysis of the image and/or the video, and obtaining the input, via the user interface, for the determined set of characteristics of the scope of work.

In some embodiments, the first electronic device is adapted for determining the set of characteristics of the scope of work by identifying one or more of a type and/or category of work permit required for the scope of work, a unique identifier, ID, for the scope of the work, a set of one or more items of equipment for performing the scope of work, a set of one or more hazards identified based on the analysis of the image and/or the video, a set of one or more items of hazard mitigation for performing the scope of work, a personal protective equipment, PPE, required for performing the scope of work, one or more competent workers to perform the scope of work, and at least one skill required for at least one competent worker to safely perform the scope of work based on the set of determined characteristics.

In some embodiments, the input identifying the scope of the work comprises one or more of: an image of the location, a video of the location, a set of characteristics of the scope of work, one or more equipment for performing the scope of work, an identifier, ID, of one or more workers competent to perform the work, competency information of one or more workers performing the work at the location, hazards identified at the location and a personal protective equipment, PPE, required for performing the work.

In some embodiments, the response message comprises one or more of: an authorization for the work permit, a date of expiry of the work permit, a time interval indicating the expiry of the work permit, a rejection of the work permit and a reason for rejection of the work permit when the work permit is rejected.

In some embodiments, wherein the first electronic device is further adapted for: receiving a permit expiry indication message from the second electronic device indicating an expiry of the work permit prior to the expiry of the work permit and receiving the response message from the second electronic device comprising an extension of work permit when the work permit is about to expire.

According to a fifth aspect of the present disclosure, there is provided a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

According to a sixth aspect of the present disclosure, a work management system comprising a second electronic device according to the third aspect and the first electronic device according to the fourth aspect is provided.

In some of the above embodiments, the user of the first device may be a machine entity or robot or other artificial intelligence or machine learning operator. In some embodiments, the equipment at a work site location may include one or more or all autonomously, semi-autonomously, or remotely controlled machinery and/or robots. The methods disclosed herein above may be configured to cause the control systems of such machinery and/or machine operators to cause their operation on work to cease or for the machinery/machine operators to be disabled if the work they are performing/would perform is not covered by a valid work-permit.

According to another aspect of the disclosed technology, a method of providing an electronic work permit authorizing a scope of work to be performed at a location of a work site, the method 200 being performed by a client application executed at a second electronic device comprises: transmitting to a first electronic device at a location, a permit authorization message identifying a scope of work to be performed at the location, in response to receiving the permit authorization request message at the first electronic device, receiving a response message from the first electronic device indicating the scope of work, and confirming, either at the first or the second electronic device that the work scope is permitted under the transmitted work permit, wherein the response message comprises a video of the work site, and wherein confirming comprises identifying features by analysing the video to identify one or more indications of work to be done at the work site and comparing these with corresponding one or more indications of work to be done under the transmitted work permit.

In some embodiments, based on the comparing finding at least one indication of work to be done at the work site does not correspond to an indication of work to be done under the transmitted work permit, transmitting an indication of the result of the comparing to the second electronic device, and at the second electronic device, responsive to receiving the transmitted indication, causing an alert to be generated at the second electronic device and/or a revised permit to be transmitted to the first electronic device, the revised permit including an indication of a scope of work corresponding to the indication of work to be done at the work site.

In some embodiments, the work is performed by machinery which is autonomously or semi-autonomously or remotely operated and responsive to the comparing confirming the work scope features identified by analysing the video which identify one or more indications of work to be done at the work site correspond to one or more indications of work to be done under the transmitted work permit, the work commences automatically.

In some embodiments, the work is performed by machinery which is autonomously or semi-autonomously or remotely operated and responsive to the comparing confirming the work scope features identified by analysing the video identified one or more indications of work to be done at the work site do correspond to one or more indications of work to be done under the transmitted work permit, causing any ongoing work to be automatically paused.

In some embodiments, any of the above aspects may additionally have features identical with or corresponding to any of the various features as explained above for any of the other aspects.

An advantage of some embodiments is that the work at the location may be managed using an electronic work permit authorizing a scope of work to be performed at a location. The electronic permit work eliminates a need of the work permit in written form.

An advantage of some embodiments is that the work permit is authorized based on an input identifying the scope of work to be performed at the location. Such an input provides the authorizing entity with a sufficient visibility of an evidence of conditions/context of the location and confidence to authorize the work permit remotely. Such a remote authorization may save time of an authorizing entity/the worker in providing/obtaining the work permit.

An advantage of some embodiments is that fines/claims may be avoided by providing immediate visibility of when the authorized work permit is expiring and an extension of work permit to the worker.

An advantage of some embodiments is that the authorizing entity may be provided with time-stamped evidence of conditions of the location and permits adherence. Thereby, the authorizing entity may efficiently manage the work to be performed at the location in real-time.

An advantage of some embodiments is that timely management interventions may be enabled to efficiently manage the work at the location based on holistic visibility of the input identifying the scope of work.

An advantage of some embodiments is that the work permit may be authorized by considering longer-term local council permissions as well as permissions issued within an associated industry/company.

An advantage of some embodiments is that a solution of providing/obtaining the electronic work permit may be integrated into a day-to-day field operations workflow providing access to the authorizing entity and the workers within a platform used to manage safety and productivity at the location. Thus, the worker may use a client application, which has been used to manage safety and productivity at location, for providing the input identifying the scope of work to be performed at the location to the authorizing entity. Also, the authorizing entity may have immediate visibility of the work permit requested by the worker alongside with other data captured by a field team on the work to be performed at the location.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A, 1B, and 1C disclose an example work management system, according to some examples;

FIG. 2 is a flowchart illustrating example method steps, according to some examples;

FIG. 3 is a flowchart illustrating example method steps, according to some examples;

FIGS. 4A-4E, 5A-5B, 6A-6C, 7A-7C, and 8A-8B disclose example illustrations for obtaining an input from a worker, according to some examples;

FIGS. 9A, 9B, and 9C disclose example illustrations for receiving a response message indicating whether or not a work permit is authorized for a scope of work to be performed at a location, according to some examples;

FIGS. 10A-10D and 11A-11F disclose example illustrations for authorizing a scope of work to be performed at a location, according to some examples;

FIGS. 12A-12D disclose example illustrations for receiving a permit expiry indication message indicating an expiry of the work permit, according to some examples;

FIG. 13 discloses an example user interface providing time stamped evidence of conditions of a location and permits adherence for managing a work at a location according to some examples;

FIG. 14 is a schematic block diagram illustrating an example apparatus according to some examples;

FIG. 15 is a schematic block diagram illustrating an example apparatus according to some examples; and

FIG. 16 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

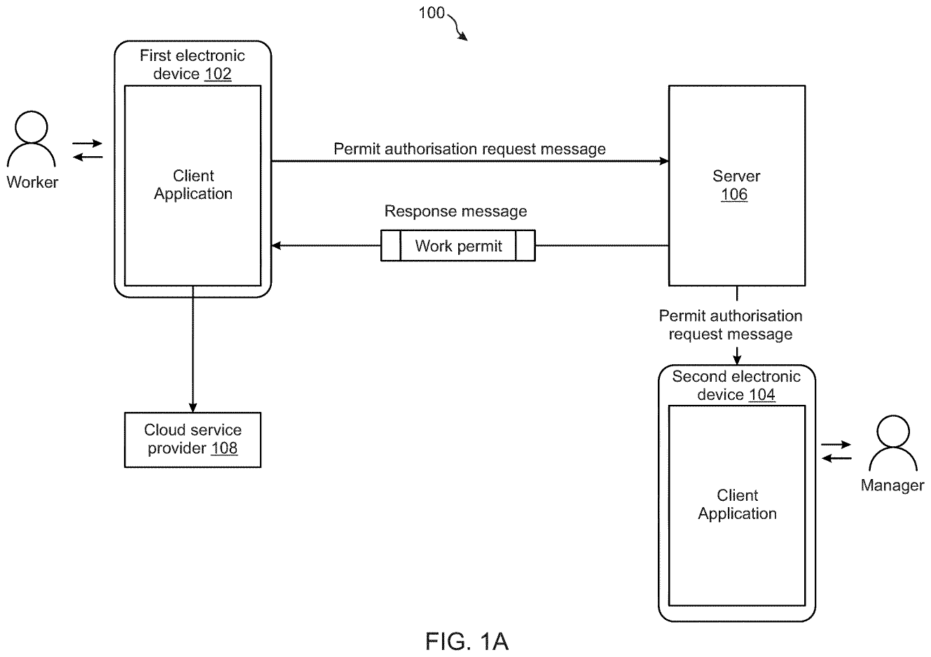

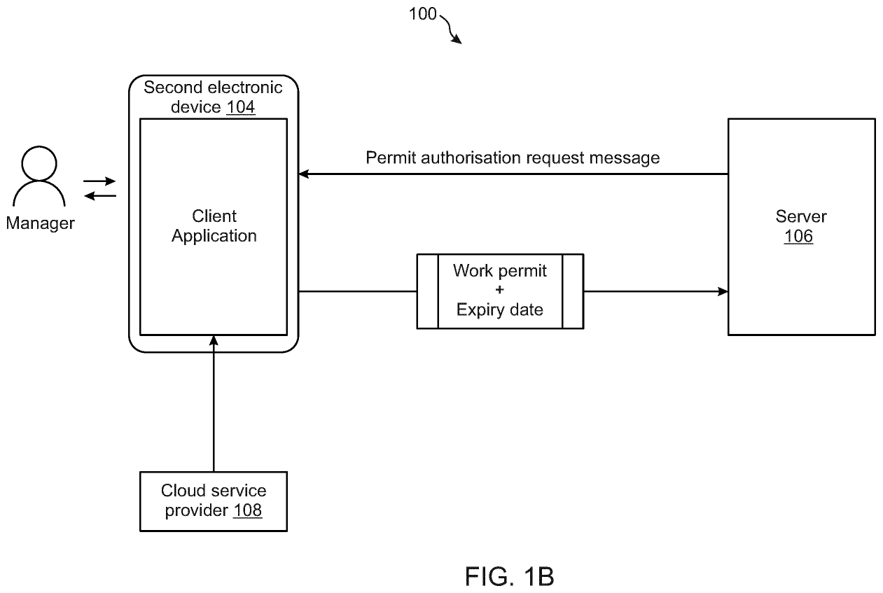

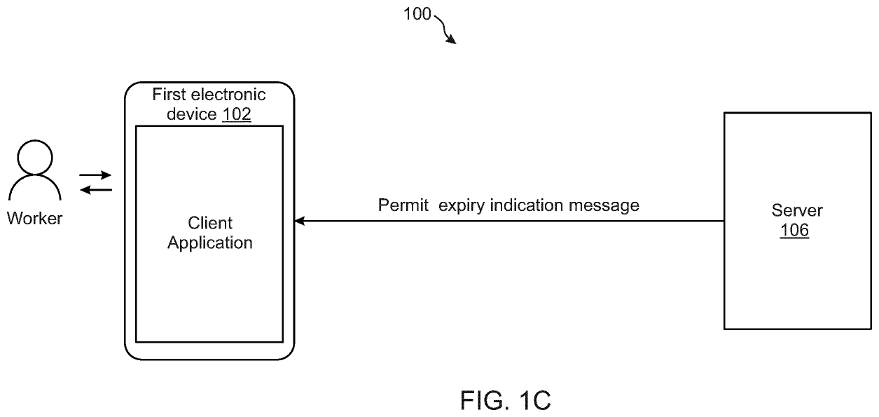

FIGS. 1A, 1B, and 1C disclose an example work management system 100. The work management system 100 referred herein may be implemented by one or more industries to manage work. In some examples, the industries may include, but are not limited to, construction industries, energy and utilities industries, and so on. In some examples, the work may include field operations, fieldwork, jobs, or the like, to be performed at a location (may also be referred to as work site) for constructing at least one object. In some examples, the at least one object may include, but is not limited to, an infrastructure object, a building, a plant in a field of oil/gas, a power generation plant, and so on.

For performing the work at the location, a worker has to obtain a work permit from an authorizing entity. The work permit authorizes the work to be performed at the location. In some examples, the authorizing entity may include, but is not limited to, a manager of the worker, administrations assigned for the location/work site, permit officers in charge of the location/work site, an authorizing engineer, and so on.

In some examples, the worker can obtain the work permit from the authorizing entity by following a legacy paper based process or a dedicated permit-management digital process. In accordance with legacy paper based process, the worker can obtain the work permit in a written form. For obtaining the work permit in the written form, the worker has to pause the work at the location, drive to the authorizing entity, complete a requesting written form and obtain the work permit in the written form being signed by the authorizing entity. Thus, the legacy paper based process consumes time of the worker and delays the work to be performed at the location. In accordance with the dedicated permit-management digital process, the worker can obtain the work permit in a digital form. However, the digital form does not capture an entire context associated with the work to be performed at the location.

Therefore, according to some embodiments of the present disclosure, the work management system 100 is provided for managing a work to be performed at a location using an electronic work permit authorizing a scope of work to be performed at the location. Thus, time consumption in obtaining/providing the work permit and delay in performing the work at the location may be reduced.

As depicted in FIG. 1A, the work management system 100 comprises a first electronic device 102, a second electronic device 104 and a server 106. In some examples, the first electronic device 102 and the second electronic device 104 may be connected to the server 106 using a communication network. In some examples, the communication network may include, but is not limited to, a wired network, a value-added network, a wireless network, a satellite network, or a combination thereof. Examples of the wired network may be, but is not limited to, a Local Area Network, LAN, a Wide Area Network, WAN, an Ethernet, and so on. Examples of the wireless network may be, but is not limited to, a cellular network, a wireless LAN, Wi-Fi, Bluetooth, Bluetooth low energy, Zigbee, Wi-Fi direct, WFD, Ultra-wideband, UWB, infrared data association, IrDA, near field communication, NFC, and so on. In some examples, the first electronic device 102 and the second electronic device 104 may be connected to the server 106 directly (for example, via a direct communication, via an access point, or the like). In some examples, the first electronic device 102 and the second electronic device 104 may be connected to the server 106 via a relay, a hub, and a gateway. It is understood that the first electronic device 102 and the second electronic device 104 may be connected to the server 106 in any of various manners (including those described above) and may be connected to each other in two or more various manners (including those described above) at the same time. In some examples, the first electronic device 102 and the second electronic device 104 may be connected with each other through the server 106. In some examples, the first electronic device 102 and the second electronic device 104 may be connected with each other using the communication network, or via the direct communication, or via the relay, the hub, and the gateway (not shown). Further, as depicted in FIGS. 1A and 1B, the first electronic device 102 and the second electronic device 104 may be connected to a cloud service provider 108 using the communication network, or via the direct communication, or via the relay, the hub, and the gateway, or the like.

The first electronic device 102 referred herein may be a device being used by a worker entitled to perform the work at the location. In embodiments disclosed herein, the worker may also be referred to as operator, field worker, user, or the like. Examples of the first electronic device may include, but are not limited to, a cellular phone, a personal digital assistant, PDA, a handheld device, a laptop computer, a wearable device, or any other device that provides a user interface for the worker to interact with the first electronic device 102. The first electronic device may present at the location at which the work is to be performed.

According to some embodiments of the present disclosure, the first electronic device 102 is adapted for obtaining an electronic work permit authorizing a scope of work to be performed at a location from the second electronic device 104. In some embodiments, the first electronic device 102 executes a client application to obtain the electronic work permit from the second electronic device 104. In some embodiments, the electronic work permit may be a configurable form comprising a set of widgets to collect structured and unstructured data/information providing sufficient evidence for remote authorization of a work permit for the scope of work to be performed at the location. In some examples, the work permit may include at least one of, but is not limited to, a permit to dig, a hot work permit, a permit to work at heights, a permit work at confined spaces, and so on. The work permit may be in compliance with state, local, and federal laws, codes and standards, or the like defined with regard to health and safety of the workers, environmental protection, and quality management. In some examples, the electronic work permit form may be customized on an administration panel according to requirements of the industries and then the customized form may be provided to the worker via the client application being executed on the first electronic device 102.

The second electronic device 104 referred herein may be a device being used by the authorizing entity (for example, a manager of the worker, administrations assigned for the location/work site, permit officers in charge of the location/work site, an authorizing engineer, or the like). Examples of the second electronic device 104 may include, but are not limited to, a computing device, a multi-processor system, a microprocessor-based or programmable consumer electronic device, a network-computing device, a minicomputer, or any other device that provides a user interface for the authorizing entity to interact with the second electronic device 104. In some examples, the computing device may include a cellular phone, a PDA, a handheld device, a laptop computer, or a combination thereof.

According to some embodiments of the present disclosure, the second electronic device 104 is adapted for providing the electronic work permit authorizing the scope of work to be performed at the location to the first electronic device 102. In some embodiments, the second electronic device 104 executes a client application to provide the electronic work permit to the first electronic device 102.

The server 106 referred herein may include, but is not limited to, a standalone server, a server deployed on a cloud, and so on. The server 106 may be adapted to enable the first electronic device 102 and the second electronic device 104 to exchange communication between each other for obtaining/providing the electronic work permit.

The cloud service provider 108 may be a third party server adapted to receive an image and/or a video of the location from the first electronic device 102 and store the received image and/or video of the location. The cloud service provider 108 may store the image and/or the video of the location in accordance with service lease agreements signed between the industry/company who implements the first electronic device 102 at the location to manage the work and the cloud service provider 108.

For managing the work to be performed at the location, as depicted in FIG. 1A, the first electronic device 102 at the location obtains an input identifying the scope of work to be performed at the location, from the worker entitled to perform the work at the location. In some examples, the input identifying the scope of work may comprise one or more of: an image of the location, a video of the location, characteristics of the scope of work, one or more equipment for performing the scope of work, an identifier, ID, of one or more workers competent to perform the work, competency information of one or more workers performing the work at the location, hazards identified at the location and a personal protective equipment, PPE, required for performing the work.

In some embodiments, for obtaining the input, the first electronic device 102 may capture an image and/or a video of the location. The first electronic device 102 may analyse the image and/or the video of the location for determining a set of characteristics of the scope of work. In some examples, the first electronic device 102 determines the set of characteristics of the scope of work by identifying one or more of: a type and/or category of the work permit required for the scope of work, a unique ID for the scope of the work, a set of one or more items of equipment for performing the scope of work, a set of one or more hazards identified based on the analysis of the image and/or the video, a set of one or more items of hazard mitigation for performing the scope of work, a PPE required for performing the scope of work, one or more competent workers to perform the scope of work, and at least one skill required for at least one competent worker to safely perform the scope of work based on the set of determined characteristics. Upon determining the set of characteristics of the scope of work, the first electronic device 102 obtains the input, via the user interface, from the worker for the determined set of characteristics of the scope of work.

Upon obtaining the input identifying the scope of work, the first electronic device 102 transmits a permit authorization request message comprising the obtained input to the server 106. In some embodiments, the first electronic device 102 may transmit the permit authorization request message comprising the input along with a server recorded ID of the worker, transmission/submission timestamp, and an ID of the work to the server 106. In some examples, the server recorded ID of the worker may be an ID assigned by the server 106 to the worker. In some examples, the transmission timestamp may indicate time of transmission. Transmission of the input along with the timestamp may result in avoiding fines/claims for the worker by providing a time stamped evidence of conditions of the location and permit adherence.

In some examples, the first electronic device 102 may upload the input identifying the scope of work to be performed at the location, the image and/or the video of the location, or the like, to the cloud service provider 108 for storage.

Upon receiving the permit authorization request comprising the input from the first electronic device 102, the server 106 forwards the permit authorization request message comprising the input to the second electronic device 104 for authorizing/reviewing the work permit. In some examples, the server 106 may forward the permit authorization request to the second electronic device 104 through at least one of: a push message, an email notification, and so on.

In some embodiments, upon receiving the permit authorization request message comprising the input, the server 106 may provide placeholder uniform resource locators, URLs, to the first electronic device 102 to upload the image and/or the video of the location, the set of characteristics of the scope of work, and so on. After providing the URLs to the first electronic device 102, the server 106 may forward the permit authorization request message comprising the input to the second electronic device 104. In some examples, the server 106 may forward the permit authorization request message along with the placeholder URLs, where the image and/or the video of the location has been uploaded to the second electronic device 104.

As depicted in FIG. 1B, in response to receiving the permit authorization request message, the second electronic device 104 transmits a response message to the server 106, which forwards the response message to the first electronic device 102. The response message indicates whether or not the work permit is authorized for the scope of work to be performed at the location. Based on the response message, the worker may perform the work at the location.

In some embodiments, for transmitting the response message, the second electronic device 104 may obtain the image and/or the video of the location. In some examples, the second electronic device 104 may obtain the image and/or the video of the location from the input received in the permit authorization request message (that is received from the first electronic device 102 through the server 106). In some examples, as depicted in FIG. 1B, the second electronic device 104 may obtain the image and/or the video of the location directly from the cloud service provider 108, leaving the server 106 out from a loop to benefit from SLAs and bandwidth provided by the cloud service provider 108. Upon obtaining the image and/or the video of the location, the second electronic device 104 analyses the image and/or the video of the location to determine whether the received input identifying the scope of the work to be performed at the location is in compliance with an authorization criteria to be fulfilled for authorizing the work permit. In some examples, the authorization criteria may include at least one of, but is not limited to, pre-defined permit conditions, competence of the one or more workers required to execute/supervise the work at the location, safety measures to be followed at the location, and so on. Based upon determination of whether the received input is in compliance with an authorization criteria, the second electronic device 104 transmits the response message to the first electronic device 102 through the server 106.

In some embodiments, the response message may indicate whether or not the work permit is authorized for the scope of work, based upon determination of whether the received input is in compliance with an authorization criteria. For example, if the received input is in compliance with the authorization criteria, the second electronic device 104 may transmit the response message to the first electronic device 102 indicating that the work permit is authorized for the scope of work to be performed at the location. If the received input is not in compliance with the authorization criteria, the second electronic device 104 may transmit the response message to the first electronic device 102 indicating that the work permit is not authorized for the scope of work to be performed at the location.

In some embodiments, the response message comprising the electronic work permit indicating whether or not the work permit is authorized for the scope of work may be provided to the first electronic device 102 as a push message.

In some embodiments, as depicted in FIG. 1B, the response message may further comprises one or more of: an authorization for the work permit, a date of expiry of the work permit, a time interval indicating the expiry of the work permit, a rejection of the work permit and a reason for rejection of the work permit when the work permit is rejected.

In some embodiments, the response message may also indicate an extension of the work permit, if the scope of work being performed at the location requires the extension of the work permit.

In some examples, the second electronic device 104 may also display, via the user interface, one or more of: a number of authorized work permits on a location map, a number of work permits about to expire, an indication for number of active work permits, an indication for the work permits that are about to expire, and one or more images of locations of the work being performed. In some examples, the second electronic device 104 may display the indication for number of active work permits, and the indication for the work permits that are about to expire in different colours. Therefore, the authorizing entity may determine to intervene the work permit based on the visibility of the one or more images of the location and permits adherence.

In some examples, the second electronic device 104 may also transmit a permit expiry indication message to the server 106. The server 106 may forward the permit expiry indication message to the server 106, as depicted in FIG. 1C. In some examples, the permit expiry indication message may indicate an expiry of the work permit prior to the expiry of the work permit. In some examples, the permit expiry indication message may indicate the expiry of the work by indicating a number of days remaining for expiry of the work permit, (for example, X days, 1 day, or the like remaining for the expiry of the work permit). In some examples, the permit expiry indication message may also indicate an expired work permit. In some examples, the number of days remaining for expiry of the work permit may be indicated in different colours.

In some embodiments, for transmitting the permit expiry indication message to the server 106, the second electronic device 104 may identify a date of expiry of the work permit authorized for the scope of work. Based on the identified date of expiry of the work permit, the second electronic device 104 monitors whether the work permit is about to expire. When it has been monitored that the work permit is about to expire, the second electronic device 104 may transmit the permit expiry indication message to the first electronic device 102 prior at a pre-configured time interval prior to the expiry of the work permit. For example, if the pre-configured time interval is 5 days, then the permit expiry indication message may be transmitted to the first electronic device when 5 days are remaining for the expiry of the work permit. Thus, fines/claims may be avoided by providing immediate visibility of when the authorized work permit is expiring.

In some examples, the second electronic device 104/the server 106 may be adapted to provide the electronic work permit authorising the scope of the work to be performed at the location to the first electronic device 102 without the first electronic device 102 having previously transmitted to the second electronic device 104 the permit authorization request message comprising the input for the electronic work permit. In some examples, the electronic work permit may be directly transmitted to the first electronic device 102 as a push message. In some examples, the second electronic device 104 may access the image and/or the video of the location from the cloud service provider 108/server 106. The second electronic device 104 may analyse the image and/or the video of the location to authorize the work permit for the scope of work to be performed at the location. Based on the analysis, the second electronic device 104 may transmit the electronic work permit indicating whether or not the work permit is authorized for the scope of work to the first electronic device 102 directly. Thereby, saving time of the worker in obtaining the work permit for performing the work at the location.

Thus, providing the electronic work permit indicating whether the work permit is authorized or not for the scope of work to be performed at the location, the permit expiry indication message indicating the expiry of work permit, and the response message comprising the extension of the work permit may aid in efficiently managing the work at the location with safety and without delay. For example, whenever a high-risk activity (i.e., the scope of work) is conducted on the location/work site, the authorization of the work permit ensures that the activity/work is carried out by a competent worker with the needed equipment and PPE in place and within the agreed timeframe.

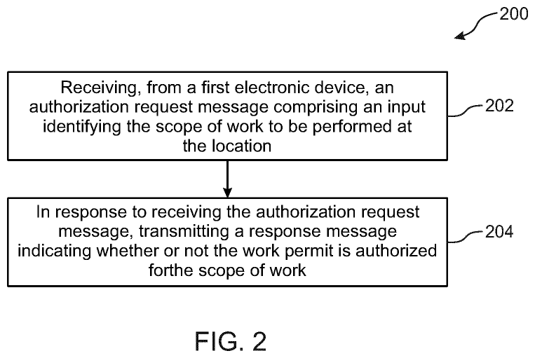

FIG. 2 is a flowchart illustrating example method steps of a computer-implemented method 200 performed by the client application being executed at the second electronic device for providing an electronic work permit authorizing a scope of work to be performed at a location.

At step 202, the method 200 comprises receiving, from the first electronic device, at the location, the permit authorization request message comprising an input identifying the scope of work to be performed at the location. In some embodiments, the input identifying the scope of work to be performed at the location may comprise one or more of: an image of the location, a video of the location, characteristics of the scope of work, one or more equipment for performing the scope of work, an ID of one or more workers competent to perform the work, competency information of one or more workers performing the work at the location, hazards identified at the location and a PPE required for performing the work.

In response to receiving the permit authorization request message, at step 204, the method 200 comprises transmitting a response message to the first electronic device indicating whether or not the work permit is authorized for the scope of work.

In some embodiments, the step 204 of transmitting the response message to the first electronic device indicating whether or not the work permit is authorized for the scope of work comprises determining whether the received input identifying the scope of the work to be performed at the location is in compliance with an authorization criteria to be fulfilled for authorizing the work permit. In some examples, the authorization criteria may include at least one of, but is not limited to, pre-defined permit conditions, competence of the one or more workers required to execute/supervise the work at the location, safety measures to be followed at the location, and so on. Based on the determination, the method comprises transmitting the response message to the first electronic device indicating whether or not the work permit is authorized for the scope of work.

In some embodiments, the step of determining whether the received input identifying the scope of the work to be performed at the location is in compliance with the authorization criteria to be fulfilled for authorizing the work permit comprises obtaining an image and/or video of the location from the received input. Based on analysis of the image and/or video of the location, the method comprises determining whether the authorization criteria is fulfilled or not.

In some examples, the response message comprising the electronic work permit may be transmitted as a push message to the first electronic device.

In some embodiments, the response message may further comprise one or more of: an authorization for the work permit, a date of expiry of the work permit, a time interval indicating expiry of the work permit, a rejection of the work permit and a reason for rejection of the work permit when the work permit is rejected.

In some embodiments, the method 200 may further comprise transmitting a permit expiry indication message to the first electronic device indicating an expiry of the work permit prior to expiry of the work permit. In some examples, the step of transmitting the permit expiry indication message to the first electronic device may comprise identifying a date of expiry of the work permit authorized for the scope of the work and monitoring whether the work permit is about to expire based on the identified date of expiry of the work permit. When it has been monitored that the work permit is about to expire, the method comprises transmitting the permit expiry indication message to the first electronic device prior at a pre-configured time interval prior to the expiry of the work permit.

In some embodiments, the method 200 may further comprise determining whether the scope of work being performed at the location requires an extension of work permit. In response to determining that the scope of work being performed at the location requires the extension of the work permit, the method comprises transmitting the response message to the first electronic device comprising the extension of work permit.

In some examples, the method 200 may further comprise displaying, via the user interface, one or more of: a number of authorized work permits on a location map, a number of work permits about to expire, an indication for number of active work permits, an indication for the work permits that are about to expire, and one or more images of locations of the work being performed.

In some embodiments, an indication of the time remaining for each permit of the multiple electronic work permits is displayed via the user interface of the second electronic device. In some embodiments, the indication of the time remaining for each permit is displayed in a way that indicates if a current prediction of the time remaining for the work to be performed whilst the permit is value is greater or less than the time remaining for the permit. In some embodiments, a traffic light system may be used to indicate a probability of the work not being completed before the permit expires, so that red indicates a high probability of the work exceeding the time permitted under the permit for performing the work, orange a medium probability, and green indicates a low or no probability. Other colours may of course substitute for the other or another visual indication may be provided. Advantageously by displaying multiple indications at the same time on a map shown on the display of the second device in some embodiments, it allows a user perceiving the display of the second device to be able to more easily prioritize which permit to review, for example, to determine one or more characteristics of the work and/or the amount of time for the permit extension.

In some embodiments, an alert may be generated a predetermined amount of time before a permit expires to a permit authorizer to indicate an extension may be requested if the probability of the work not being completed whilst the permit is valid exceeds a threshold probability value. The predetermined amount of time may be set by a user, and may differ from location to location and for different permits. For example, a user may set an alert that if the work has a low likelihood of overrunning at one location for which a permit is quickly extended, that an alert is set for 30 minutes before expiry of the permit. However, for work at a different location, where the work has a high probability of overrunning and/or for which obtaining a permit extension may be more time-consuming, the alert may be generated 24 hours in advance so that there is sufficient time to obtain the permit extension or to take other action if the permit is not extendable directly.

Any suitable prediction technique may be used to determine if the work may be completed on time or not, however, in some embodiments the prediction of the amount of time remaining to complete the work is based on an input identifying a scope of work completed at a point in time. For example, an input comprising one or more of the following: a manual input by a remote user/entity, an input by a work-site user, for example, by a worker performing the work to which the work scope applies, an input generated by performing video analysis of the location indicating a scope of work completed by the point in time, and/or a previously input scope of work and/or the permit work scope.

An alternative embodiment of the computer implemented method 200 for providing an electronic work permit authorizing a scope of work to be performed at a location pushes the work permit to a user at the work site. This may happen if a manager realises that a permit is needed based on off-line information in which case a permit may be pushed to the client without first requiring a permit authorisation request message to be received from the first electronic device. In such embodiments, the method 200 performed by the client application executed at the second electronic device 104 comprises transmitting to a first electronic device 102 at a location, a permit authorization message identifying a scope of work to be performed at the location, and, in response to receiving the permit authorization request message at the first electronic device, receiving a response message from the first electronic device 102 indicating the scope of work, and confirming, either at the first or the second electronic device that the work scope is permitted under the transmitted work permit.

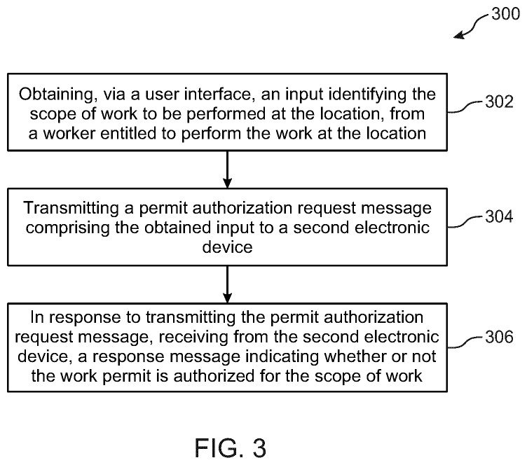

FIG. 3 is a flowchart illustrating example method steps of a computer-implemented method 300 performed by the client application being executed at the first electronic device for obtaining an electronic work permit authorizing a scope of work to be performed at a location.

At step 302, the method 300 comprises obtaining, via a user interface, an input identifying the scope of work to be performed at the location, from the worker entitled to perform the work at the location. In some examples, the input identifying the scope of the work comprises one or more of: an image of the location, a video of the location, a set of characteristics of the scope of work, one or more equipments for performing the scope of work, an ID of one or more workers competent to perform the work, competency information of one or more workers performing the work at the location, hazards identified at the location and a PPE required for performing the work.

In some embodiments, the step 302 of obtaining the input identifying the scope of work to be performed at the location may comprise capturing an image and/or a video of the location. The method may comprise analysing the image and/or the video of the location for determining a set of characteristics of the scope of work. For the determined set of characteristics of the scope of work, the method may comprise obtaining the input, via the user interface, from the worker.

In some embodiments, the step of determining the set of characteristics of the scope of work comprises identifying one or more of: a type and/or category of the work permit required for the scope of work, a unique ID, for the scope of the work, a set of one or more items of equipment for performing the scope of work, a set of one or more hazards identified based on the analysis of the image and/or video, a set of one or more items of hazard mitigation for performing the scope of work, a PPE, required for performing the scope of work, one or more competent workers to perform the scope of work, and at least one skill required for at least one competent worker to safely perform the scope of work based on the set of determined characteristics.

At step 304, the method 300 comprises transmitting a permit authorization request message comprising the obtained input to the second electronic device. In some examples, the permit authorization request message comprising the input may be transmitted to the electronic device through the server. In some examples, the permit authorization request message comprising the input may be transmitted to the electronic device as a push message or an email notification.

In response to transmitting the permit authorization request message, at step 306, the method 300 comprises receiving, from the second electronic device, a response message indicating whether or not the work permit is authorized for the scope of work. In some examples, the response message may comprise one or more of: an authorization for the work permit, date of expiry of the work permit, a time interval indicating expiry of the work permit, a rejection of the work permit and a reason for rejection of the work permit when the work permit is rejected.

In some embodiments, the method 300 may further comprise receiving a permit expiry indication message from the second electronic device indicating an expiry of the work permit prior to the expiry of the work permit. The method 300 may also comprise receiving a response message from the second electronic device comprising an extension of work permit when the work permit is about to expire.

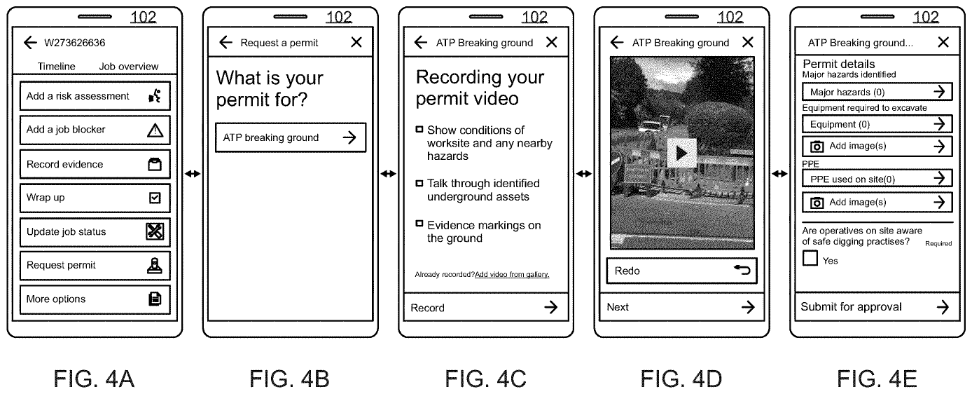

FIGS. 4A-4E, 5A-5B, 6A-6C, 7A-7C, and 8A-8B disclose example illustrations of obtaining an input from a worker, which identify a scope of work to be performed at a location. The first electronic device 102 obtains, via the user interface, the input identifying the scope of work to be performed at the location, from the worker entitled to perform the work at the location. The first electronic device 102 transmits a permit authorization request message comprising the obtained input to the second electronic device/authorizing entity for obtaining a response message comprising the electronic work permit. The electronic work permit may indicate whether or not the work permit is authorized for the scope of work. In some examples, the input identifying the scope of the work comprises one or more of: an image of the location, a video of the location, a set of characteristics of the scope of work, one or more types of equipment and/or one or more equipment items for performing the scope of work, an ID of one or more workers competent to perform the work, competency information of one or more workers performing the work at the location, hazards identified at the location and a PPE required for performing the work.

Consider an example scenario, wherein the worker entitled to work at the location wants to obtain the electronic work permit for performing a work at the location. In an example herein, the work may include a digging work/operation. In such a scenario, as depicted in FIG. 4A, the first electronic device 102 at the location displays an ID of the scope of work (i.e., a job ID, for example, W273626636), a timeline option, a job overview option, and one or more options related to the work/job on the user interface. In some examples, the timeline option may provide information about a timeline for completion of the work at the location and the job overview option may provide information about the scope of work to be performed at the location. In an example herein, the one or more options may include an “Add a risk assessment” option for adding any risks/hazards associated with the work, an “Add a job blocker” option, a “Record evidence” option to upload an image and/or a video of the location, a “Wrap up” option, an “Update job status” option, a “Request permit” option, and so on. For instance, consider that the worker selects the “Request permit” option. In such a scenario, as depicted in FIG. 4B, the first electronic device 102 allows the worker to select the work for which the electronic work permit is required. In an example herein, the worker selects an “ATP breaking ground” as the work for which the electronic work permit is required. After selecting the work, as depicted in FIG. 4C, the first electronic device 102 allows the worker to record the video of the location for authorizing the work permit. In some examples, the first electronic device 102 may allow the worker to record the video by depicting at least one of: conditions of the location/worksite and any nearby hazards, identified underground assets, evidence markings on a ground, or the like. In some examples, the first electronic device 102 may also enable the worker to upload the recorded video of the location. Once the video is recorded and uploaded, as depicted in FIG. 4D, the first electronic device 102 determines a set of characteristics of the scope of work based on analysis of the video of the location and allows the worker to provide the input for the determined set of characteristics. In an example herein, as depicted in FIG. 4E, the determined set of characteristics may include:
a set of one or more hazards identified based on the analysis of the video (major hazards identified);
a set of one or more items of equipment for performing the scope of work (equipment required to excavate);
PPE required for performing the scope of work (PPE); and
one or more competent workers to perform the scope of work and at least one skill required for at least one competent worker to safely perform the scope of work based on the set of determined characteristics (are operative on site aware of safe digging practices).

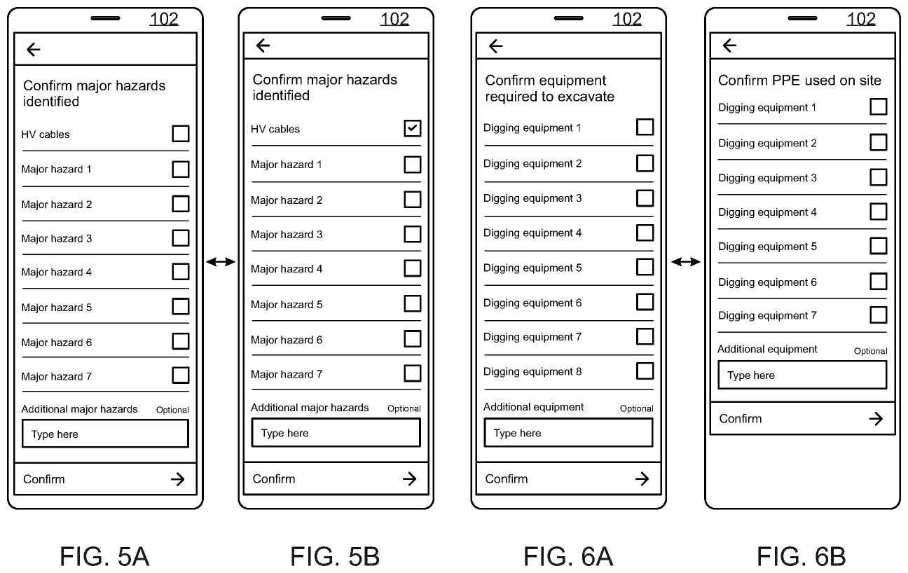

When the worker wants to provide the input for the one or more identified hazards, the first electronic device 102 displays one or more hazards identified (for example, HV cables, major hazard 1-major hazard 7) and allows the worker to confirm the displayed at least one hazard, as depicted in FIG. 5A. Also, the first electronic device 102 may allow the worker to manually enter one or more hazards identified by the worker. For instance, as depicted in FIG. 5B, the worker confirms HV cables as the identified major hazard.

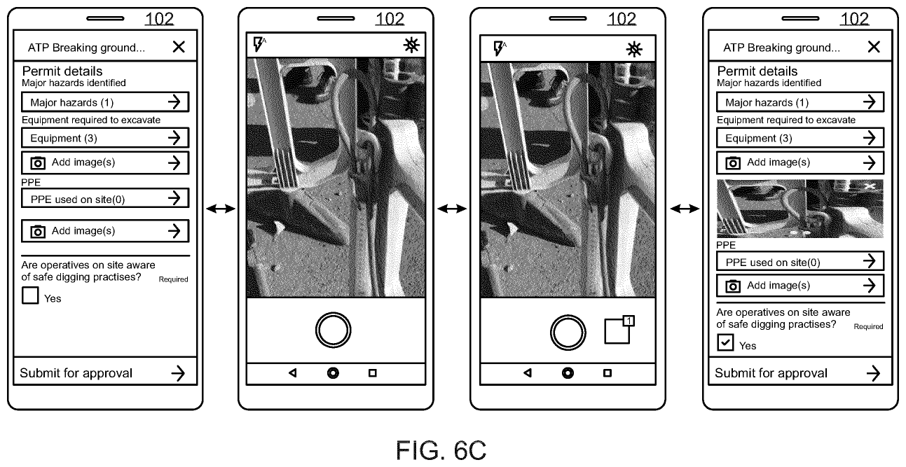

When the worker wants to provide the input for the one or more equipment for performing the scope of work, the first electronic device 102 displays the one or more equipment identified for performing the scope of work and allows the worker to confirm the at least one equipment, as depicted in FIG. 6A. Further, the first electronic device 102 allows the worker to confirm the PPE for the confirmed at least one equipment, as depicted in FIG. 6B. In addition, the first electronic device 102 allows the worker to upload the image of the at least one equipment required for performing the scope of work, as depicted in FIG. 6C.

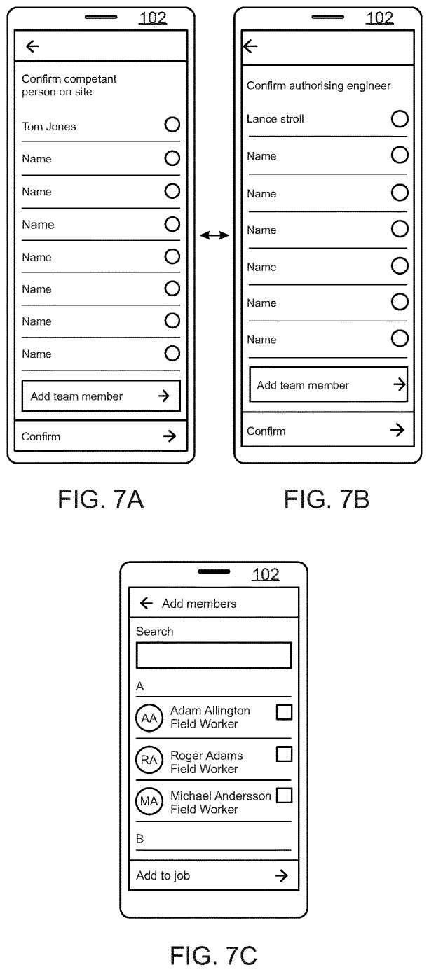

When the worker wants to provide the input related to the one or more competent workers, the first electronic device 102 displays names of one or more competent workers and allows the worker to confirm the at least one competent worker for performing the work at the location, as depicted in FIG. 7A. Also, the first electronic device 102 displays names of the authorizing entities and allows the worker to confirm the at least one authorizing entity for authorizing the work permit required for performing the work at the location, as depicted in FIG. 7B. In addition, the client application allows the worker to manually suggest/add names of workers/members for performing the work at the location, as depicted in FIG. 7C.

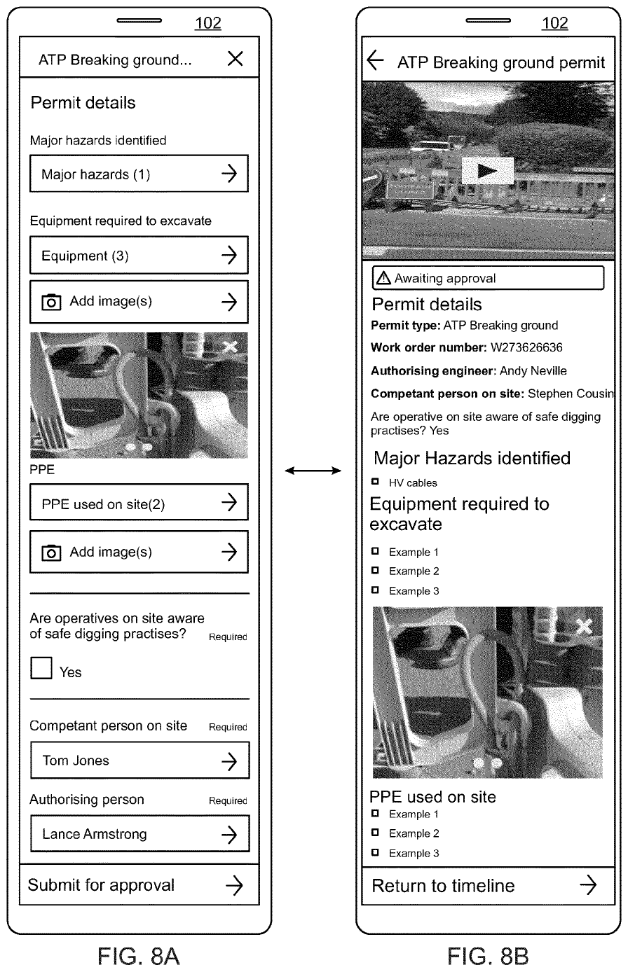

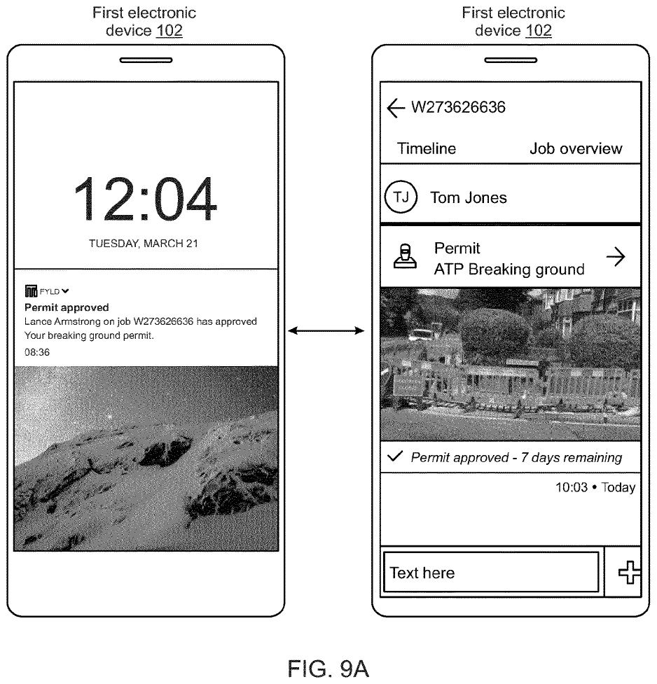

After receiving the input from the worker for the determined set of characteristics, the first electronic device 102 allows the worker to select a “Submit for approval” option, as depicted in FIG. 8A. Once the worker selects the “Submit for approval” option, the first electronic device 102 transmits the permit authorization request message comprising the input, as depicted in FIG. 8B, to the second electronic device. In response to transmitting the permit authorization request message, the first electronic device 102 receives a response message comprising the electronic work permit, which indicates whether or not the work permit is authorized for the scope of work. Thus, the worker may perform the work at the location, based on the response message.

In some embodiments, the first electronic device 102 may also upload the input obtained from the worker to the cloud service provider for storage, wherein the input may identify the scope of work to be performed at the location.

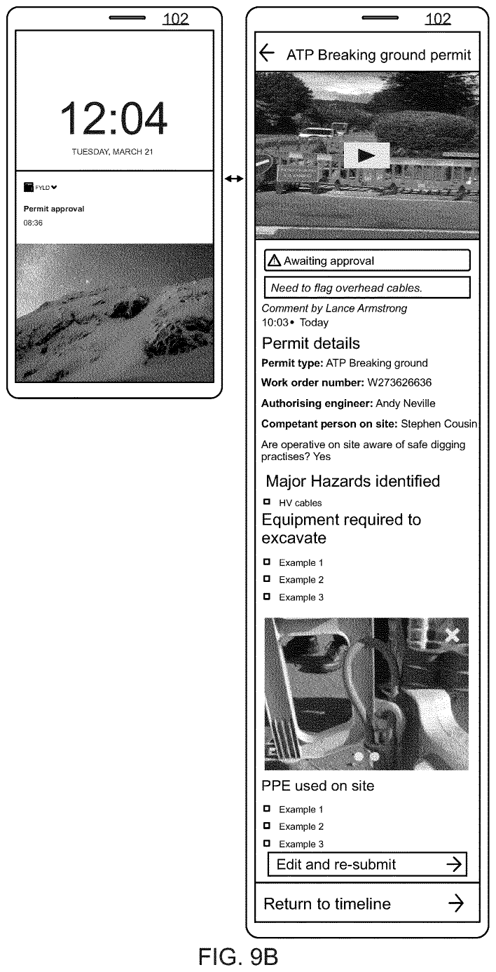

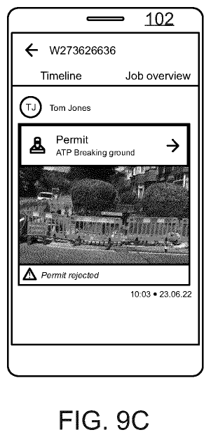

FIGS. 9A, 9B, and 9C disclose example illustrations of receiving a response message indicating whether or not a work permit is authorized for a scope of work to be performed at a location. The first electronic device 102 transmits a permit authorization request message comprising an input identifying a scope of work to be performed to the second electronic device. In response to transmitting the permit authorization request message, the first electronic device 102 receives the response message from the second electronic device, which comprises the electronic work permit indicating whether or not the work permit is authorized for the scope of work.

In some examples, the first electronic device 102 may receive the response message as a push message, as depicted in FIGS. 9A and 9B.

In some examples, as depicted in FIG. 9A, the response message may indicate an approval of the work permit to perform the work at the location, when the input identifying the scope of the work to be performed at the location is in compliance with an authorization criteria to be fulfilled for authorizing the work permit. In some examples, the authorization criteria may include at least one of, but is not limited to, pre-defined permit conditions, competence of the one or more workers required to execute/supervise the work at the location, safety measures to be followed at the location, and so on.

In some examples, as depicted in FIG. 9B, the response message may indicate a reason for pending approval, when the authorizing entity requires one or more additional inputs for authorizing the work permit. In an example herein, as depicted in FIG. 9B, the response message indicates a need to flag overhead cables. In such a scenario, the first electronic device 102 allows the worker to edit the input. Once the input has been edited, the first electronic device 102 retransmits/re-submits the permit authorization request message comprising the edited input to the second electronic device for obtaining the electronic work permit.

In some examples, as depicted in FIG. 9C, the response message may indicate a rejection of the work permit to perform the work at the location, when the input identifying the scope of the work to be performed at the location is not in compliance with the authorization criteria to be fulfilled for authorizing the work permit.

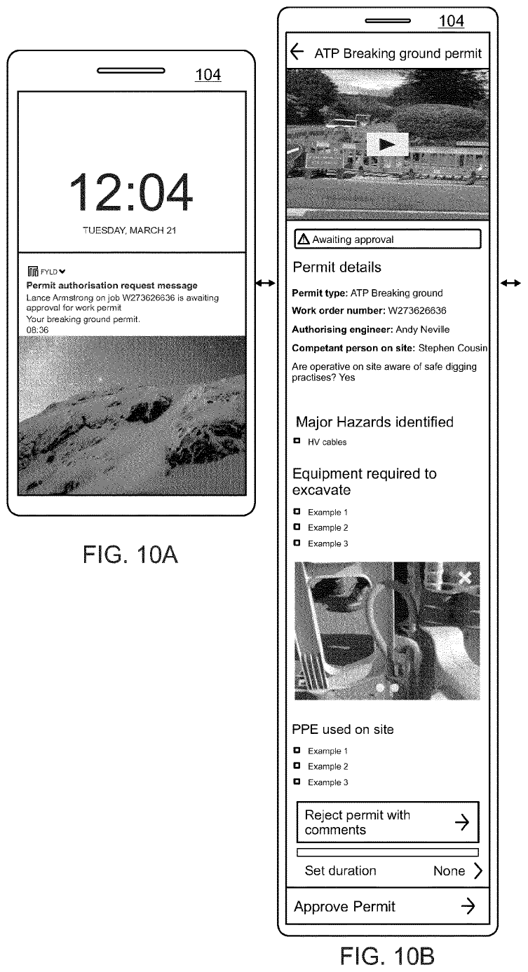

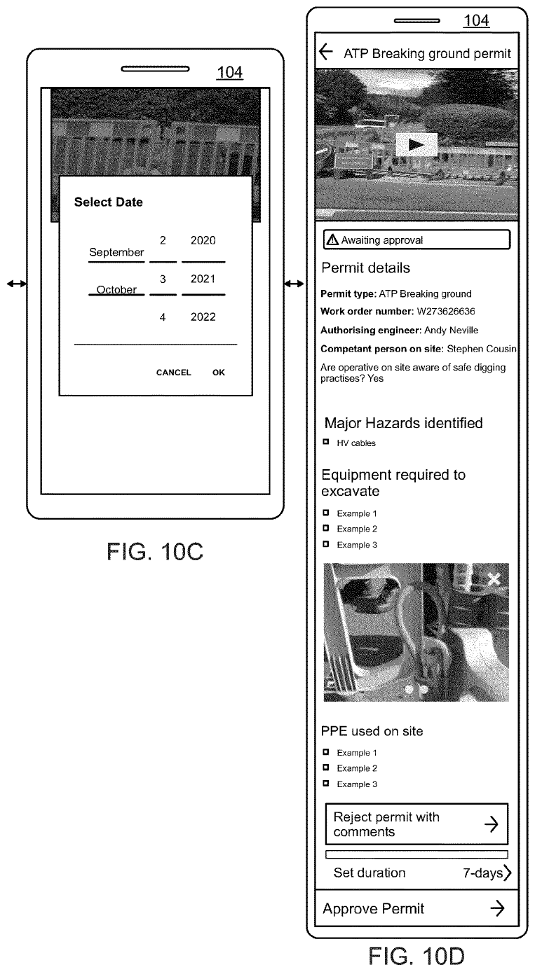

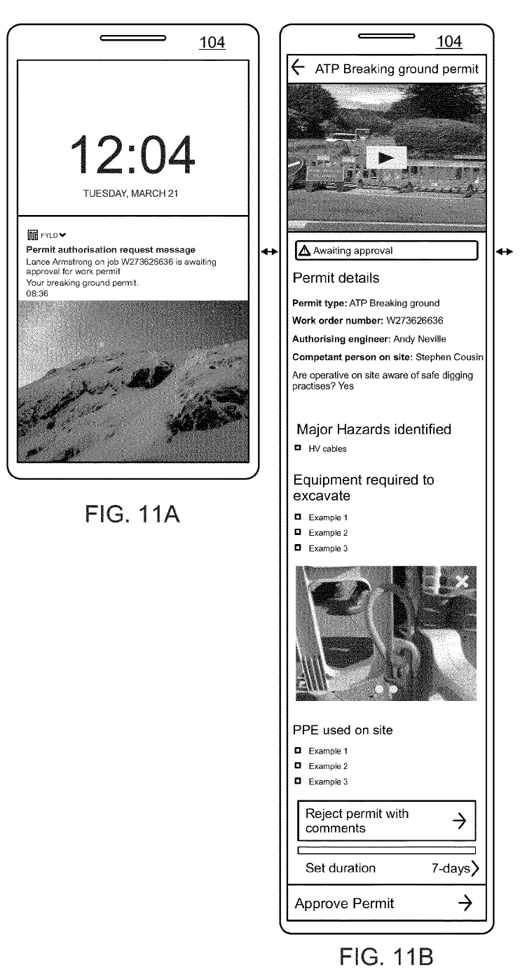

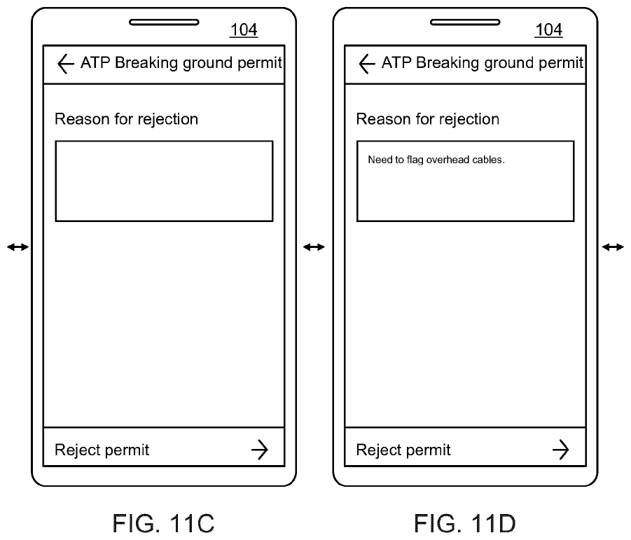

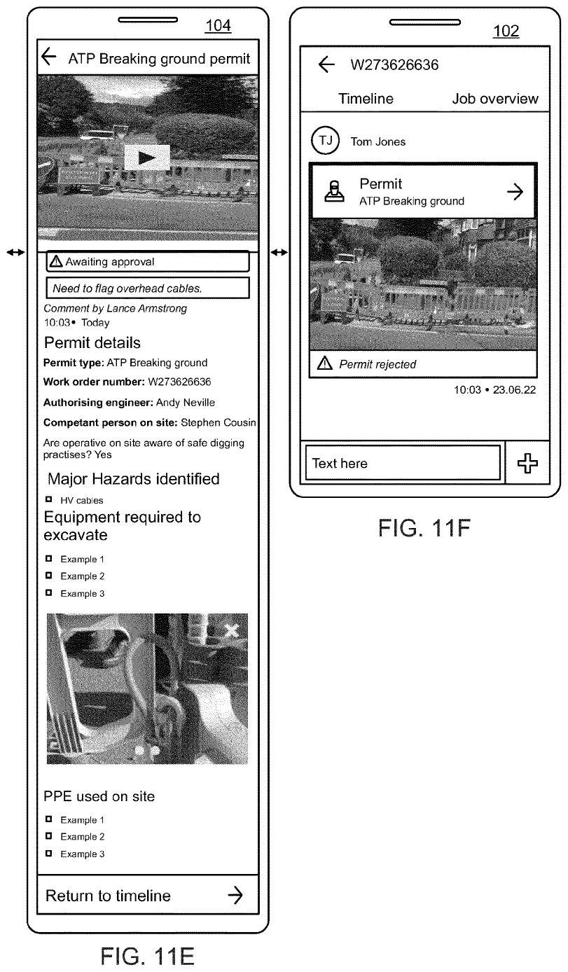

FIGS. 10A-10D, and 11A-11F disclose example illustrations of authorizing a scope of work to be performed at a location. The second electronic device 104 being used by the authorizing entity receives, from the first electronic device at the location, a permit authorization request message comprising an input identifying the scope of work to be performed at the location. In response to receiving the permit authorization request message, the second electronic device 104 authorizes the input and transmits the response message to the first electronic device indicating whether or not the work permit is authorized for the scope of work.

Consider an example scenario, as depicted in FIGS. 10A and 11A, wherein the second electronic device 104 receives the permit authorization request message as the push message. The permit authorization request message comprises the input obtained from the worker entitled to perform the work at the location. When the authorization entity clicks the push message, the second electronic device 104 displays the input identifying the scope of work to be performed at the location and options such as an “Reject permit with comments” option, a “set duration” option, and an “Approve Permit” option, as depicted in FIG. 10B, and 11B. The second electronic device 104/authorizing entity determines whether the received input identifying the scope of the work to be performed at the location is in compliance with an authorization criteria to be fulfilled for authorizing the work permit. In some examples, the authorization criteria may include at least one of, but is not limited to, pre-defined permit conditions, competence of the one or more workers required to execute/supervise the work at the location, safety measures to be followed at the location, and so on.

In an example, consider that the input is in compliance with the authorization criteria to be fulfilled for authorizing the work permit. In such a scenario, the second electronic device 104 approves the work permit and allows the authorizing entity to set a duration (i.e., a date of expiry) for the approved work permit, as depicted in FIG. 10C. Once the duration is set for the work permit, the second electronic device 104 transmits the response message comprising the electronic work permit indicating the approval of the work permit with the date of expiry to the first electronic device/worker, as depicted in FIG. 10D.

In another example, consider that the input is in compliance with the authorization criteria to be fulfilled for authorizing the work permit. In such a scenario, the second electronic device 104 rejects the work permit and provides an option for the authorizing entity to manually enter a reason for rejecting the work permit, as depicted in FIG. 11C. In an example herein, the authorizing entity enters the reason for rejecting the work permit as “Need to flag overhead cables”, as depicted in FIG. 11D. Once the reason for rejecting the work permit is entered by the authorizing entity, the second electronic device 104 adds the reason for rejecting the work permit in the response message, as depicted in FIG. 11E. Thereafter, the second electronic device 104 transmits the response message indicating rejection of the work permit to the first electronic device 102. The first electronic device 102 displays the response message indicating rejection of the work permit to the worker, as depicted in FIG. 11F.

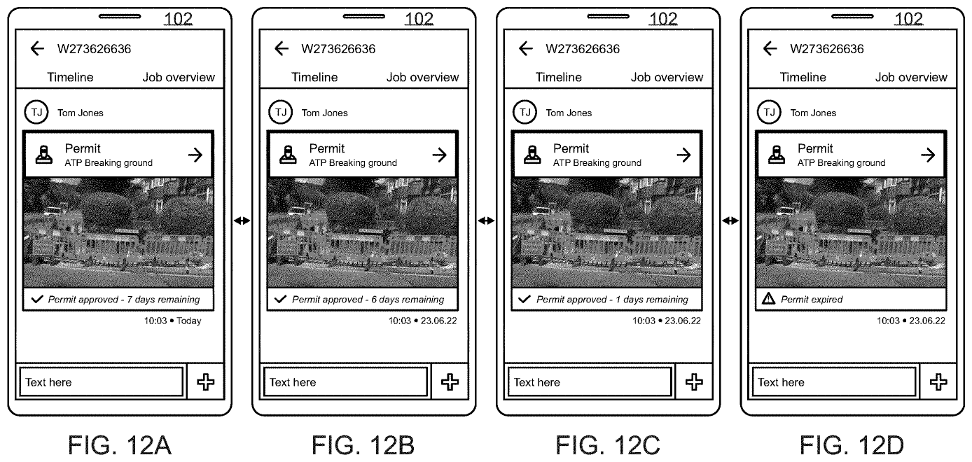

FIGS. 12A-12D disclose example illustrations of receiving a permit expiry indication message indicating an expiry of the work permit. The first electronic device 102 receives the permit expiry indication message from the second electronic device prior to expiry of the work permit. In such a scenario, the permit expiry indication message indicates a number of days remaining for expiry of the work permit, as depicted in FIGS. 12A, 12B, and 12C.

Also, the first electronic device 102 receives the permit expiry indication message after the expiry of the work permit. In such a scenario, the permit expiry indication message indicates that the work permit is expired, as depicted in FIG. 12D.

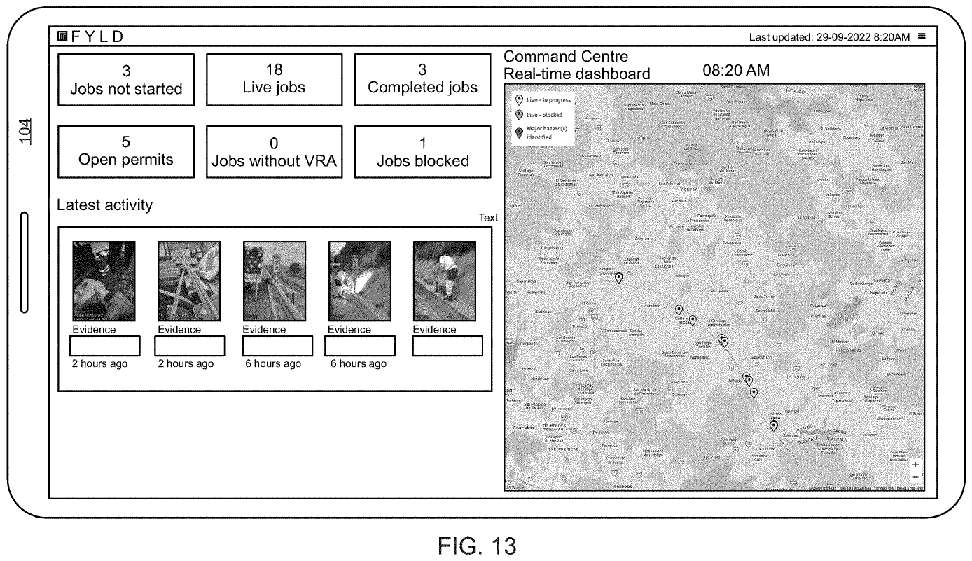

FIG. 13 disclose an example user interface providing time stamped evidence of conditions of a location and permits adherence for managing a work at a location. In embodiments herein, the second electronic device provides a real-time dashboard to the authorizing entity via the user interface. The real-time dashboard provides real-time visibility about the permits adherence. The permits adherence may show at least one of: a number of work/jobs that have not been started, ongoing/live jobs, completed jobs, open work permits, a number of jobs that have been blocked/rejected, a number of jobs without video risk assessment, VRA.

In some examples, the authorizing entity may be allowed to view the open work permits, the work permits that have been blocked, and the work permits associated with major hazards on a map in different colours. Also, the open work permits may be displayed on the map in different colours, based on the associated date of expiry.

In some examples, the authorizing entity may be allowed to click a pin on the work for determining a need to intervene the work permit provided for the work.

The real-time dashboard also provides the time stamped evidence of the conditions of the location. Therefore, the authorizing entity may have visibility to all the real-time activities/work being performed at the location.

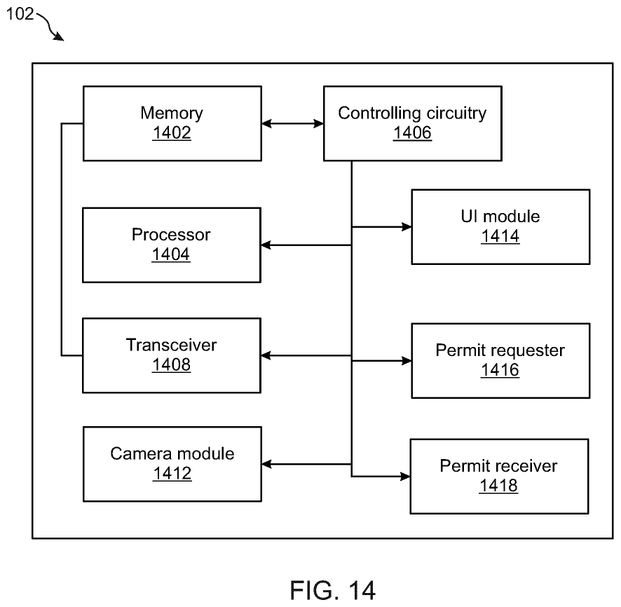

FIG. 14 is an example schematic diagram showing an apparatus 102. The apparatus 102 may e.g., be comprised in a first electronic device. The apparatus 102 is capable of obtaining an electronic work permit authorizing a scope of work to be performed at a location and may be configured to cause performance of the method 300 for obtaining the electronic work permit.

According to at least some embodiments of the present invention, the apparatus 102 in FIG. 14 comprises one or more modules. These modules may e.g. be a memory 1402, a processor 1404, a controlling circuitry 1406, a transceiver 1408, a camera module 1412, a user interface (UI) module 1414, a permit requester 1416, and a permit receiver 1418. The controlling circuitry 1406, may in some embodiments be adapted to control the above mentioned modules.

The memory 1402, the processor 1404, the transceiver 1408, the camera module 1412, the UI module 1414, the permit requestor 1416, and the permit receiver 1418 as well as the controlling circuitry 1406, may be operatively connected to each other.

The controlling circuitry 1406 may be adapted to control the steps as executed by the first electronic device. For example, the controlling circuitry 1406 may be adapted to obtain the electronic work permit authorizing the scope of work to be performed at the location (as described above in conjunction with the method 300 and FIG. 3).

The camera module 1412 may be adapted to capture an image and/or a video of the location. The image and/or the video of the location may be analysed by the permit requestor 1416 to determine a set of characteristics of the scope of work to be performed at the location.

The transceiver 1408 may be adapted to transmit the captured image and/or the video of the location and information about the set of characteristics of the scope of the work to the cloud service provider for storage.

The UI module 1414 may be adapted to provide a user interface through which an input from a worker entitled to work at a location may be received for the set of characteristics of the scope of work. The input identifies the scope of work to be performed at the location.

The permit requester 1416 may be adapted to create the permit authorization request message by including the input obtained from the worker.

The transceiver 1408 may be adapted to transmit the permit authorization request message to the second electronic device through the server for obtaining the work permit.

In response to transmitting the permit authorization request message, the transceiver 1408 may also be adapted to receive a response message from the second electronic device through the server. The response message may comprise the electronic work permit indicating whether or not the work permit is authorized for the scope of work.

The transceiver 1408 may also be adapted to transmit the electronic work permit to the cloud service provider for storage.

The permit receiver 1418 may be adapted to enable the UI module 1414 to provide the response message comprising the electronic permit to the worker. Therefore, the worker may perform the work at the location in accordance with the obtained electronic work permit.

The transceiver 1408 may also be adapted to receive placeholder URLs from the server.

The processor 1404 may be adapted to upload the image and/or the video of the location on the server using the received placeholder URLs.

The memory 1402 may store at least one of, but is not limited to, the client application, the permit authorization request message, the response message comprising the electronic work permit, the image and/or the video of the location, the set of characteristics of the scope of work, and so on. The client application is being executed by the controlling circuitry 1406 to obtain the electronic work permit authorizing the scope of work to be performed at the location.

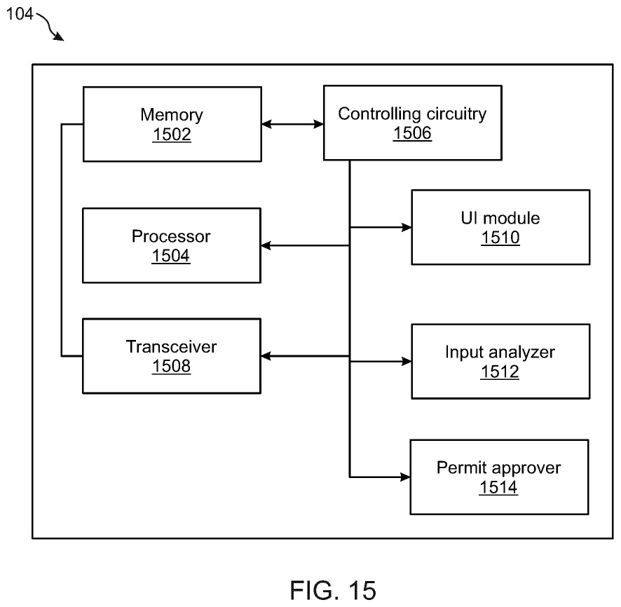

FIG. 15 is an example schematic diagram showing an apparatus 104. The apparatus 104 may e.g., be comprised in a second electronic device. The apparatus 104 is capable of providing an electronic work permit authorizing a scope of work to be performed at a location to the first electronic device and may be configured to cause performance of the method 200 for providing the electronic work permit.

According to at least some embodiments of the present invention, the apparatus 104 in FIG. 15 comprises one or more modules. These modules may e.g. be a memory 1502, a processor 1504, a controlling circuitry 1506, a transceiver 1508, a UI module 1510, an input analyser 1512, and a permit approver 1514. The controlling circuitry 1506, may in some embodiments be adapted to control the above mentioned modules.

The memory 1502, the processor 1504, the transceiver 1508, the UI module 1510, the input analyser 1512, and the permit approver 1514 as well as the controlling circuitry 1506, may be operatively connected to each other.

The controlling circuitry 1506 may be adapted to control the steps as executed by the second electronic device. For example, the controlling circuitry 1506 may be adapted to provide the electronic work permit authorizing the scope of work to be performed at the location to the first electronic device (as described above in conjunction with the method 200 and FIG. 2).

The transceiver 1508 may be adapted to receive a permit authorization request message from the first electronic device through the server. The permit authorization request message comprises an input identifying the scope of work to be performed at the location.

The UI module 1510 may be adapted to provide a user interface through which the permit authorization request message comprising the input identifying the scope of work is displayed to the authorizing entity.

The input analyser 1512 may be adapted to determine whether the received input identifying the scope of the work to be performed at the location is in compliance with an authorization criteria to be fulfilled for authorizing the work permit. In some examples, the input analyser 1512 may be adapted to receive an assistance from the authorizing entity to determine whether the received input identifying the scope of the work to be performed at the location is in compliance with the authorization criteria to be fulfilled for authorizing the work permit.

The permit approver 1514 may be adapted to create a response message based on determination of whether the received input identifying the scope of the work to be performed at the location is in compliance with an authorization criteria to be fulfilled for authorizing the work permit. The response message may comprise an authorization for the work permit, a date of expiry of the work permit, a time interval indicating expiry of the work permit, a rejection of the work permit and a reason for rejection of the work permit when the work permit is rejected.

The permit approver 1514 may also be adapted to determine an expiry of the work permit.

The permit approver 1514 may also be adapted to determine an extension of work permit required for the scope of work to be performed at the location.

The transceiver 1508 may be adapted to transmit the response message to the first electronic device through the server. The transceiver 1508 may also be adapted to transmit a permit expiry indication message indicating the expiry of the work permit to the first electronic device prior to the expiry of the work permit. The transceiver 1508 may also be adapted to transmit transmitting the response message to the first electronic device comprising the extension of work permit.

The processor 1504 may be adapted to receive the image and/or the video of the location from the cloud service provider through the transceiver and analyses the image and/or video of the location. Analysis of the image and/or video of the location may be used for determining whether the received input identifying the scope of the work to be performed at the location is in compliance with the authorization criteria to be fulfilled for authorizing the work permit.

The UI module 1510 may also be adapted to provide a real-time dashboard for the authorizing entity via the user interface. The real-time dashboard provides time stamped evidence of the conditions of the location and permits adherence.

The memory 1502 may store at least one of, but is not limited to, the client application, the permit authorization request message, the response message comprising the electronic work permit, the image and/or the video of the location, the authorization criteria, and so on. The client application is being executed by the controlling circuitry 1506 to provide the electronic work permit authorizing the scope of work to be performed at the location to the first electronic device.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

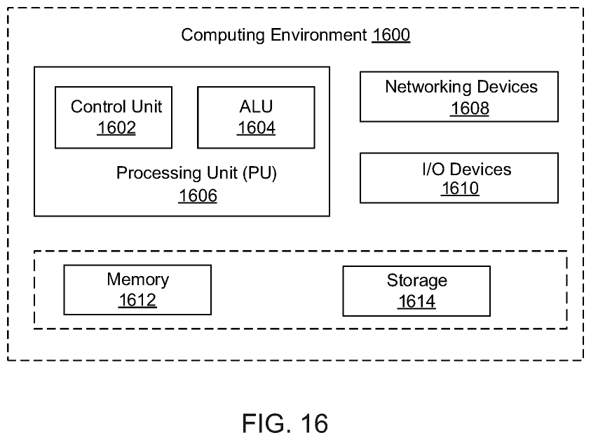

FIG. 16 illustrates an example computing environment 1600 implementing methods 200, 300 and electronic devices 104, 102, as described in FIGS. 2, 3, 14 and 15. As depicted in FIG. 16, the computing environment 1600 comprises at least one data processing module 1606 that is equipped with a control module 1602 and an Arithmetic Logic Unit (ALU) 1604, a plurality of networking devices 1608 and a plurality Input output, I/O devices 1610, a memory 1612, a storage 1614. The data processing module 1606 may be responsible for implementing the method described in FIGS. 2 and 3. For example, the data processing module 1606 may in some embodiments be equivalent to the CPU/processor of the electronic devices described above in conjunction with the FIGS. 14 and 15. The data processing module 1606 is capable of executing software instructions stored in memory 1612. The data processing module 1606 receives commands from the control module 1602 in order to perform its processing. Further, any logical and arithmetic operations involved in the execution of the instructions are computed with the help of the ALU 1604.

The computer program is loadable into the data processing module 1606, which may, for example, be comprised in an electronic apparatus (such as an electronic device). When loaded into the data processing module 1606, the computer program may be stored in the memory 1612 associated with or comprised in the data processing module 1606. According to some embodiments, the computer program may, when loaded into and run by the data processing module 1606, cause execution of method steps according to, for example, any of the method illustrated in FIGS. 2 and 3 or otherwise described herein.

The overall computing environment 1600 may be composed of multiple homogeneous and/or heterogeneous cores, multiple CPUs of different kinds, special media and other accelerators. Further, the plurality of data processing modules 1606 may be located on a single chip or over multiple chips.

The algorithm comprising of instructions and codes required for the implementation are stored in either the memory 1612 or the storage 1614 or both. At the time of execution, the instructions may be fetched from the corresponding memory 1612 and/or storage 1614, and executed by the data processing module 1606.

In case of any hardware implementations various networking devices 1608 or external I/O devices 1610 may be connected to the computing environment to support the implementation through the networking devices 1608 and the I/O devices 1610.

In some embodiments, the user of the first electronic device may be a machine entity. In some embodiments, the user of the first electronic device may be a robot or other automated machine operator of machinery at the work site location. In some embodiments, a skilled worker may be an operator of remote or semi-autonomous machinery at the work site. In some embodiments, instead of a skilled worker based at the site operating machinery at the work site location, the machinery at the work site location may be autonomous or remotely operated. The skilled worker may be augmented by a robotic exoskeleton in some embodiments, and the robotic exoskeleton may incorporate the first device in some embodiments.

In some embodiments, a method of providing an electronic work permit authorizing a scope of work to be performed at a location of a work site is provided where the method is performed by a client application executed at a second electronic device and the method comprises: transmitting to a first electronic device at a location, a permit authorization message identifying a scope of work to be performed at the location; in response to receiving the permit authorization request message at the first electronic device, receiving a response message from the first electronic device indicating the scope of work, and confirming, either at the first or the second electronic device that the work scope is permitted under the transmitted work permit, wherein the response message comprises a video of the work site, and wherein confirming comprises identifying features by analysing the video to identify one or more indications of work to be done at the work site and comparing these with corresponding one or more indications of work to be done under the transmitted work permit.

In some embodiments, based on the comparing finding at least one indication of work to be done at the work site does not correspond to an indication of work to be done under the transmitted work permit, transmitting an indication of the result of the comparing to the second electronic device, and at the second electronic device, responsive to receiving the transmitted indication, causing an alert to be generated at the second electronic device and/or a revised permit to be transmitted to the first electronic device, the revised permit including an indication of a scope of work corresponding to the indication of work to be done at the work site.

In some embodiments, the work is performed by machinery which is autonomously or semi-autonomously or remotely operated and responsive to the comparing confirming the work scope features identified by analysing the video which identify one or more indications of work to be done at the work site correspond to one or more indications of work to be done under the transmitted work permit, the work commences automatically.

In some embodiments, the work is performed by machinery which is autonomously or semi-autonomously or remotely operated and responsive to the comparing confirming the work scope features identified by analysing the video identified one or more indications of work to be done at the work site do not correspond to one or more indications of work to be done under the transmitted work permit, causing any ongoing work to be automatically paused. For example, the work may be paused until another permit is received from the second device, the second device having added the necessary indications to the permit work scope to allow the work to recommence.

The embodiments disclosed herein can be implemented through at least one software program running on at least one hardware device and performing network management functions to control the elements. The elements shown in FIG. 16 include blocks which can be at least one of a hardware device, or a combination of hardware device and software module.

1.-15. (canceled)

16. A computer implemented method for analyzing a video from a location to enable obtaining an electronic work permit authorizing a work to be performed at the location, the method being performed by a client application executed at a first electronic device, the method comprising:
analyzing a video captured at the location;
determining a set of characteristics of the work based on the analyzing of the video;
for the determined set of characteristics of the work, prompting, via a user interface, an input from a worker;
transmitting a permit authorization request message comprising the obtained input to a second electronic device; and
in response to transmitting the permit authorization request message, receiving from the second electronic device, a response message indicating whether or not the work permit is authorized for the work.

17. The computer implemented method according to claim 16, wherein the permit authorization request message further comprises the video of the location.

18. The computer implemented method according to claim 16, wherein the step of determining the set of characteristics of the work comprises identifying one or more of:
a set of one or more items of equipment for performing the work;
a set of one or more hazards identified based on the analysis of the video;
a personal protective equipment, PPE, required for performing the work; and
one or more competent workers to perform the work.

19. The computer implemented method according to claim 18, wherein the step of determining the set of characteristics of the work further comprises identifying one or more of:
a type and/or category of work permit required for the scope of work;
a unique identifier, ID, for the scope of the work;
a set of one or more items of hazard mitigation for performing the work; and
at least one skill required for at least one competent worker to safely perform the work.

20. The computer implemented method according to claim 16, wherein the input comprises one or more of: availability of one or more equipment, an identifier, ID, of one or more workers, competency information of one or more workers, hazards identified at the location and availability of a personal protective equipment, PPE.

21. The computer implemented method according to claim 16, wherein the response message comprises one or more of: an authorization for the work permit, a date of expiry of the work permit, a time interval indicating the expiry of the work permit, a rejection of the work permit and a reason for rejection of the work permit when the work permit is rejected.

22. The computer implemented method according to claim 16, wherein the method further comprises:
receiving a permit expiry indication message from the second electronic device indicating an expiry of the work permit prior to the expiry of the work permit; and
receiving the response message from the second electronic device comprising an extension of the work permit when the work permit is about to expire.

23. A first electronic device configured to analyze a video from a location to enable obtaining an electronic work permit authorizing a work to be performed at the location through a client application executed at the first electronic device, the first electronic device is being adapted for:
capturing a video of the location;
determining a set of characteristics of the work based on an analysis of the captured video of the location;
for the determined set of characteristics of the work prompting, via a user interface, an input;
transmitting a permit authorization request message comprising the obtained input to a second electronic device; and
in response to transmitting the permit authorization request message, receiving from the second electronic device, a response message indicating whether or not the work permit is authorized for the work.

24. The first electronic device according to claim 23, wherein the permit authorization request message further comprises the video of the location.

25. The first electronic device according to claim 23, wherein the first electronic device is adapted for determining the set of characteristics of the work by identifying one or more of:
a set of one or more items of equipment for performing the work;
a set of one or more hazards identified based on the analysis of the image and/or the video;
a personal protective equipment, PPE, required for performing the work; and
one or more competent workers to perform the work.

26. The first electronic device according to claim 25, wherein the first electronic device is further adapted for determining the set of characteristics of the work by identifying one or more of:
a type and/or category of work permit required for the work;
a unique identifier, ID, for the work;
a set of one or more items of hazard mitigation for performing the work; and
at least one skill required for at least one competent worker to safely perform the work.

27. The first electronic device according to claim 23, wherein the input comprises one or more of: availability of one or more equipment, an identifier, ID, of one or more workers, competency information of one or more workers, hazards identified at the location and availability of a personal protective equipment, PPE.

28. The first electronic device according to claim 23, wherein the response message comprises one or more of: an authorization for the work permit, a date of expiry of the work permit, a time interval indicating the expiry of the work permit, a rejection of the work permit and a reason for rejection of the work permit when the work permit is rejected.

29. The first electronic device according to claim 23, wherein the first electronic device is further adapted for:
receiving a permit expiry indication message from the second electronic device indicating an expiry of the work permit prior to the expiry of the work permit; and
receiving the response message from the second electronic device comprising an extension of work permit when the work permit is about to expire.

30. A non-transitory computer readable medium, having stored thereon a computer program comprising program instructions, the computer program is loadable into a data processing unit and configured to cause execution of the method according to claim 1 when the computer program is run by the data processing unit.
